(19) United States
(12) Patent Application Publication
(10) Pub. No.: US 2007/0192197 A1
(43) Pub. Date: Aug. 16, 2007

(54) Prepaid service using rewriteable card

(76) Inventor: David Landis Fisher JR., Fort Mill, SC (US)

Correspondence Address: David L. Fisher, Jr., 150 Lake Pointe Drive, Fort Mill, SC, 29708, US

(21) Appl. No.: 11/353,633

(22) Filed: Feb. 15, 2006

(51) Int. Cl. G06Q 20/00

(52) U.S. Cl. 705/16

(57) ABSTRACT

A rewriteable plastic card is an ideal token for a prepaid service program. Prepaid service is popular in the automotive retail industry where automobile owners may be entitled to a certain number of future maintenance service items such as oil changes, tire rotations, and fuel treatments. The cost of such a program may be added in to the purchase price of the vehicle, or in some cases it may be furnished by the dealership as a marketing/sales incentive. The rewriteable card allows the cardholder to see at a glance their current status in the program. Specifically, details about recent service visits and the number of remaining unused service items can be read from the face of the card and updated with each use.

### RELATED APPLICATIONS

| | |
|---|---|
| 5,448,279 | Matsuda, et al. |
| 5,448,284 | Matsuda, et al. |
| 5,490,956 | Kito et al. |
| 5,932,869 | Gottlich, et al. |
| 6,648,222 | McDonald, et al. |
| 6,718,319 | Fisher |

### FEDERAL SPONSORED R&D

None.

### FIELD OF THE INVENTION

This invention relates to using rewriteable card technology to implement a prepaid service program. Rewriteable cards are the shape of a typical credit card and are available in two thickness options (10 mil and 30 mil). The rewriteable plastic cards are finished with a thin film layer that produces visible print when the correct heat is applied by a special type of POS (point of sale) terminal. In a similar thermo process the print can also be erased. In this manner the card can be rewritten hundreds of times by the terminal. Several manufacturers produce various types of rewriteable cards and the corresponding terminals that can print/erase these cards.

An online system is one in which all of the account information and all of the business rules for redemption of the prepaid items are managed by the central server in real time. The online rewriteable terminals in the field communicate directly with the server to retrieve/update/manage account information and reprint the cards accordingly.

### BACKGROUND OF THE INVENTION

Card based programs do not typically have a means to communicate dynamic information to the cardholder. While it is possible to read the static account number from a gift card, the plastic won't convey to the cardholder the current account balance or details about the most recent purchase. Further, most card based transaction systems are not fully online. The clearing system for a credit card transaction will typically send back to the POS a simple approval or denial code. However, such a proprietary, dial up network is not capable of implementing more sophisticated programs. Specifically, a prepaid service program requires that the server send the appropriate service choices down to the terminal for customer selection and then following up with decisions about eligibility, prior usage, redemption rules, etc. Finally, the results of this transaction need to be conveyed back to the customer. The standard “approval code” that is typical of payment based systems is not sufficient for a prepaid service program. Instead, the cardholder needs detailed results of the transaction including services redeemed and the type and number of remaining services.

Consider a prepaid program for retail automotive. At the time a customer purchases a vehicle they would be offered the opportunity to pre-purchase future maintenance services. Currently offered prepaid programs within the automotive industry are administered using coupon books, punch cards, peel off stickers, and credit card style implementations that are subject to the limitations discussed above. All of these have shortcomings with respect to cost, efficiency, and customer acceptance.

### DESCRIPTION OF THE PRIOR ART

U.S. Pat. Nos. 5,448,284 and 5,448,279 to Matsuda, et al. introduces a thermo chromatic card but does not apply this to consumer oriented applications. U.S. Pat. No. 6,648,222 to McDonald, et al discloses a card based fund transfer system which uses the internet to centrally manage account balances. It fails to anticipate the advantages of rewriteable cards as well it is limited to payment systems. No. 5,932,869 to Gottlich, et al teaches of a stand alone rewriteable card based system “without the need for the transaction unit to communicate with a central memory or processing unit”. It is not able to achieve the advantage realized by an online, centrally managed system. None of the prior art anticipate implementing prepaid service in the manner disclosed.

### SUMMARY OF THE INVENTION

It is therefore an object of the present invention to overcome the aforementioned drawbacks and to implement a prepaid service management program using rewriteable card technology.

A first aspect of the present invention is that the card is printed/rewritten at the point of sale with a terminal.

A second aspect of the present invention is the rewriteable terminal communicates to the central server through an always-on internet connection.

A third aspect of the present invention is that the central server contains the business rules for prepaid programs as well as the database and generally all of the “smarts” necessary for the application.

A fourth aspect of the present invention is to use broadband internet for connectivity to create a real time application as opposed to traditional off-line solutions that submit data through dial up or batch.

These and other aspects of the present invention will become more readily apparent from the attached drawings and detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 illustrates the system components including the rewriteable cards and terminal, central server, and always-on connectivity through the internet.

FIG. 2 illustrates an example of what might be printed on a rewriteable card at the conclusion of a transaction.

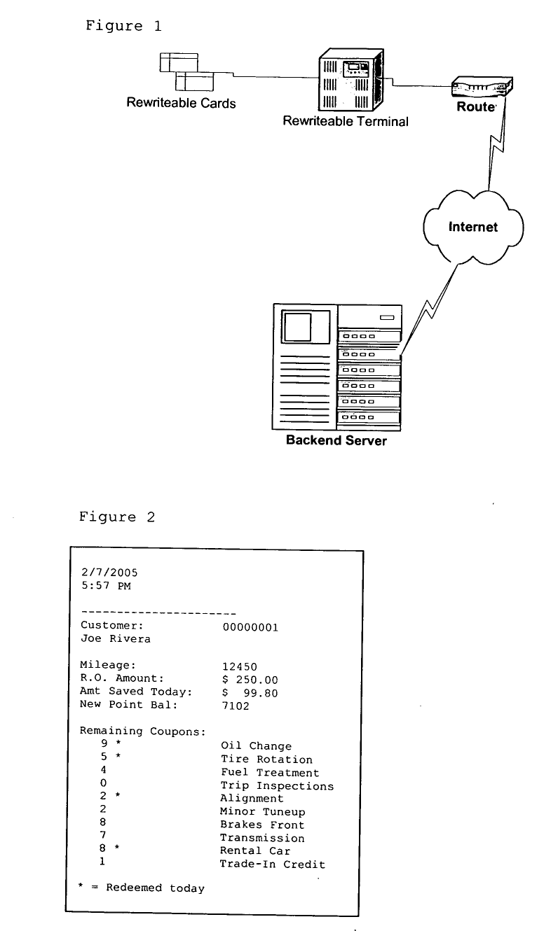

The present invention will become more fully understood from the detailed description given below.

### DETAILED DESCRIPTION OF THE INVENTION

A prepaid service program is implemented using centrally controlled online rewriteable POS terminals capable of printing dynamic data in a human readable area on the face of a plastic card.

Essential components include:
Plastic card that has been finished with a heat sensitive film that gives it rewriteable properties. As such, the rewriteable card can visibly show the cardholder his/her current status within the program.
POS terminal that can erase and reprint the rewriteable card every time it is inserted into the POS terminal.
Online connectivity through the internet to a central server. The server instructs the terminal as to what menu prompts to display, the rules of use, when and how to collect input from the terminal operator, and what should be printed on the card.
   A typical transaction sequence consists of the following steps:
1. The card is inserted into the rewriteable device.
2. The terminal reads the magnetic stripe on the back of the card and transmits this value to the central server over the internet.
3. The server performs a lookup in the database and then retrieves information about the cardholder and the corresponding prepaid program to which he is a member.
4. This information is relayed back to the terminal which will then prompt for selection of service items to be redeemed.
5. The terminal will then send the selections back to the server where the account will be updated and a final verification process is completed.
6. The terminal will erase the face of the card and print back to it the new status and participation information.
   Consider a specific implementation within an automobile dealership. The dealer determines in advance what services they intend to offer as part of a promotion. Service items could include some number of typical automotive repair/warranty items such as: oil changes, tire rotations, inspections, fuel treatments, etc. Each of these service items is valid for a certain amount of time or for specified mileage intervals. The composition of the program as well as expiration dates and mileage levels may be defined as part of the dealer configuration. Each customer receives a rewriteable card as part of their vehicle purchase. The card is encoded with a unique account number on its magstripe. When the customer returns to the dealership for service they present their card, it is inserted into the POS terminal, which in turn communicates with the central server through the dealership's internet connection. The server will lookup the cardholder information as well as the dealership information in the central database. The business logic on the server will process the “rules of use” and compute the unused services that are still available to the cardholder. The server then instructs the terminal to prompt for which of the available services are to be redeemed today. The terminal and server continue to exchange data through the duration of the transaction. Finally, the transaction will be completed and the card will be erased and reprinted with an account summary. FIG. 2 illustrates what might be printed on the face of a rewriteable card after being used to redeem prepaid automotive services.

What is claimed is:

1. A method for a prepaid service program using centrally controlled online rewriteable point-of-sale terminals capable of erasing and then reprinting account status data to the face of a plastic card consisting of the following steps:
(a) a card is inserted into the rewriteable terminal;
(b) the terminal reads the account number from the magnetic stripe and transfers this value to a central server over the internet;
(c) the central server retrieves from the database cardholder information including details of the prepaid program to which the cardholder is a member and the unused prepaid services that are still available;
(d) specific cardholder information is relayed back to the terminal which then prompts for the desired prepaid service items and account activity;
(e) the terminal transmits the selections back to the server for final verification and account updating;
(f) the terminal erases the face of the card and prints back to it the new status and updated participation information.

2. Method of claim 1 where all system wide data and associated business rules are centrally maintained on a single server that communicates to the rewriteable POS terminals over the internet.

3. Method of claim 1 where the status to be rewritten might include: program eligibility, promotional incentives, redeemable coupons, point accumulation, and/or account balances.

4. Method in claim 1 implemented for automotive warranty and maintenance where the card is reprinted with updated vehicle service information.

5. Method of claim 1 where the rewriteable properties of the card are made possible by one of several processes including: chemical rewriteable, magnetic, thermosensitive, or physical rewriteable.
